(19) United States
(12) Patent Application Publication
(10) Pub. No.: US 2011/0079114 A1
(43) Pub. Date: Apr. 7, 2011

(54) RATCHET DEVICE

(76) Inventor: CHING-HSIANG CHEN, Taichung City (TW)

(21) Appl. No.: 12/574,225

(22) Filed: Oct. 6, 2009

(51) Int. Cl. B25B 13/46

(52) U.S. Cl. 81/63

(57) ABSTRACT

A ratchet device has a ratchet body, a rotating rod and a switching device. The ratchet body has a top and a central hole axially defined through the ratchet body. The rotating rod is mounted in the central hole and has a top and at least one lump notch defined on the top of the rotating rod. The switching device has a cover, a pivoting block and a switch. The cover is mounted securely on the top of the ratchet body and has a top. The pivoting block is mounted through the cover and abuts the top of the rotating rod and has a bottom and an eccentric lump. The eccentric lump protrudes from the bottom of the pivoting block and is inserted into one of the at least one lump notch. The switch is pivotally mounted in the cover and has a through hole mounted around the pivoting block.

### BACKGROUND OF THE INVENTION

1. Field of the Invention

The present invention relates to a device for a ratchet wrench, and more particularly to a ratchet device.

2. Description of Related Art

With reference to FIG. 8, a conventional ratchet device comprises a ratchet head (80) and a switching device (90).

The ratchet head (80) has a ratchet body (81) and a pawl (82). The ratchet body (81) is substantially cylindrical and has an outer surface, a central hole (811) and a pawl opening (812).

The central hole (811) is axially defined through the ratchet body (81). The pawl opening (812) is radially defined in the outer surface of the ratchet body (81), has a semi-round cross section and communicates with the central hole (811).

The pawl (82) is pivotally mounted in the pawl opening (812).

The switching device (90) is mounted on the ratchet body (81) and has a cover (91), a knob spring (92) and a knob (93).

The cover (91) is mounted rotatably in the central hole (811) and has a top, a bottom, a protrusion, a rib (911) and a knob hole (912).

The protrusion is formed on and protrudes from the bottom of the cover (91) and is mounted in the central hole (811).

The rib (911) is formed on the top of the cover (91). The knob hole (912) is radially defined in the protrusion of the cover (91).

The knob spring (92) is compressibly mounted in the knob hole (912). The knob (93) is mounted in and protrudes out from the knob hole (912), abuts with the pawl (82) and the knob spring (92), such that the knob spring (92) provides a pushing force to the knob (93) to press against the pawl (82).

A conventional manual wrench (C) has a ratchet surface (C1). The conventional ratchet device is mounted in the manual wrench (C) and the pawl (82) engages the ratchet surface (C1). An operational direction of the ratchet device can be changed by rotation of the cover (91).

However, the conventional ratchet device has some drawbacks.

1. Awkward Operation

The rib (911) is smooth and needs to be rotated. When a user's hands are greasy or slippery, it is difficult to rotate the cover (91) and to change the operational direction.

2. Lack of Positioning Design

When the cover (91) is rotated in an arbitrary or unexpected range, the pawl (82) does not engage the ratchet surface (C1) well. Therefore, a relative rotation between the pawl (82) and the ratchet surface (C1) frequently occurs and the cover (91) needs to be rotated again to provide engagement.

3. Inconvenient Use

The manual wrench (C) has to be held to rotate the cover (91) with both hands, which is inconvenient.

To overcome the shortcomings, the present invention tends to provide a ratchet device to obviate the aforementioned problems.

### SUMMARY OF THE INVENTION

The objective of the invention is to provide a ratchet device which makes different pawl sides selectively engage the ratchet surface with a rotational-direction switch.

A ratchet device has a ratchet body, a rotating rod and a switching device. The ratchet body has a top and a central hole axially defined through the ratchet body. The rotating rod is mounted in the central hole and has a top and at least one lump notch defined on the top of the rotating rod. The switching device has a cover, a pivoting block and a switch. The cover is mounted securely on the top of the ratchet body and has a top. The pivoting block is mounted through the cover and abuts the top of the rotating rod and has a bottom and an eccentric lump. The eccentric lump protrudes from the bottom of the pivoting block and is inserted into one of the at least one lump notch. The switch is pivotally mounted in the cover and has a through hole mounted around the pivoting block.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a manual wrench with a ratchet device in accordance with the present invention;

FIG. 2 is an exploded perspective view of the ratchet device in FIG. 1;

FIG. 3 is an enlarged operational side view in partial section of the ratchet device in FIG. 1, wherein the “L” sign is pressed;

FIG. 4 is an enlarged operational side view in partial section of the ratchet device in FIG. 1;

FIG. 5 is an enlarged operational side view in partial section of the ratchet device in FIG. 4, wherein the pivoting block is pressed down;

FIG. 6 is an enlarged perspective view of the ratchet device in FIG. 1, wherein the pawl and the pawl pin are shown;

FIG. 7 shows operational top views of the ratchet device in FIGS. 3 and 4; and

FIG. 8 is an exploded perspective view of a conventional ratchet device in accordance with the prior art.

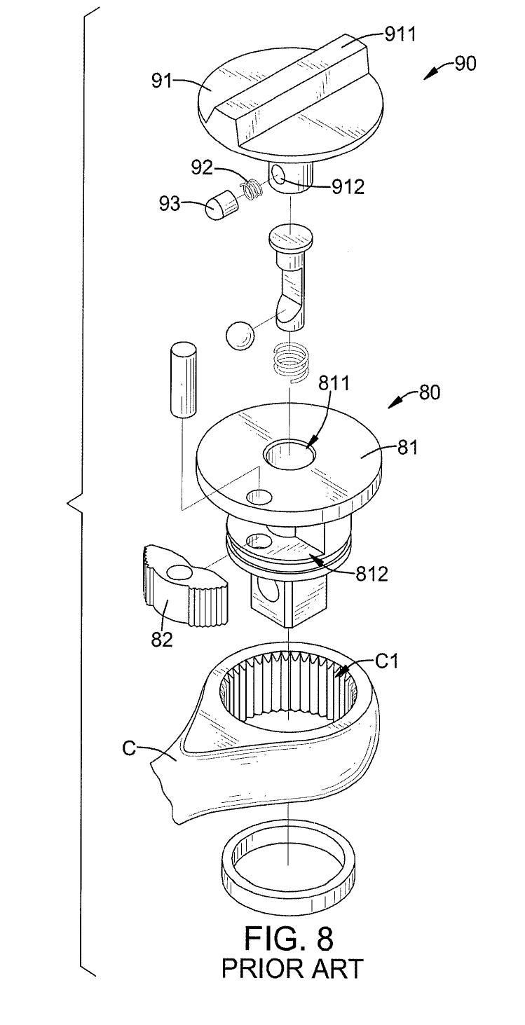

### DETAILED DESCRIPTION OF PREFERRED EMBODIMENT

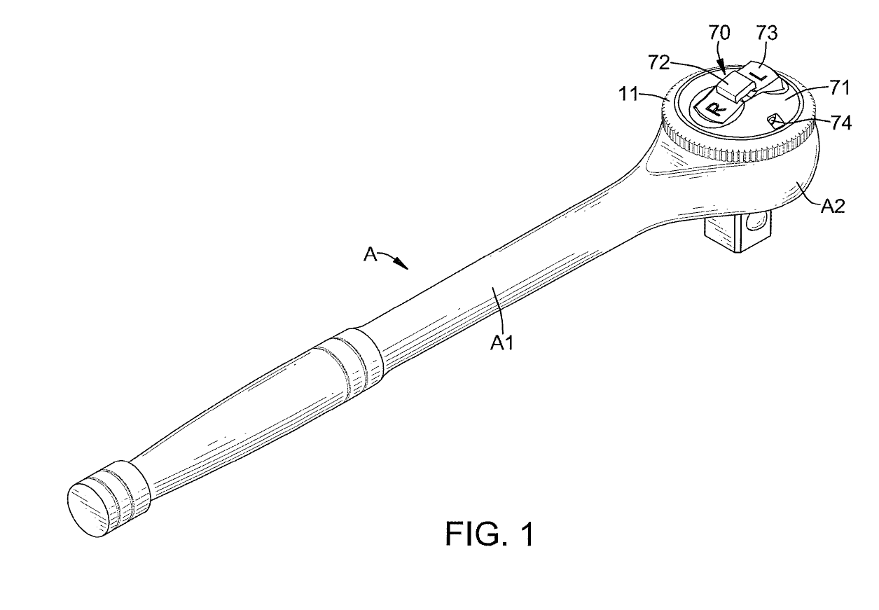

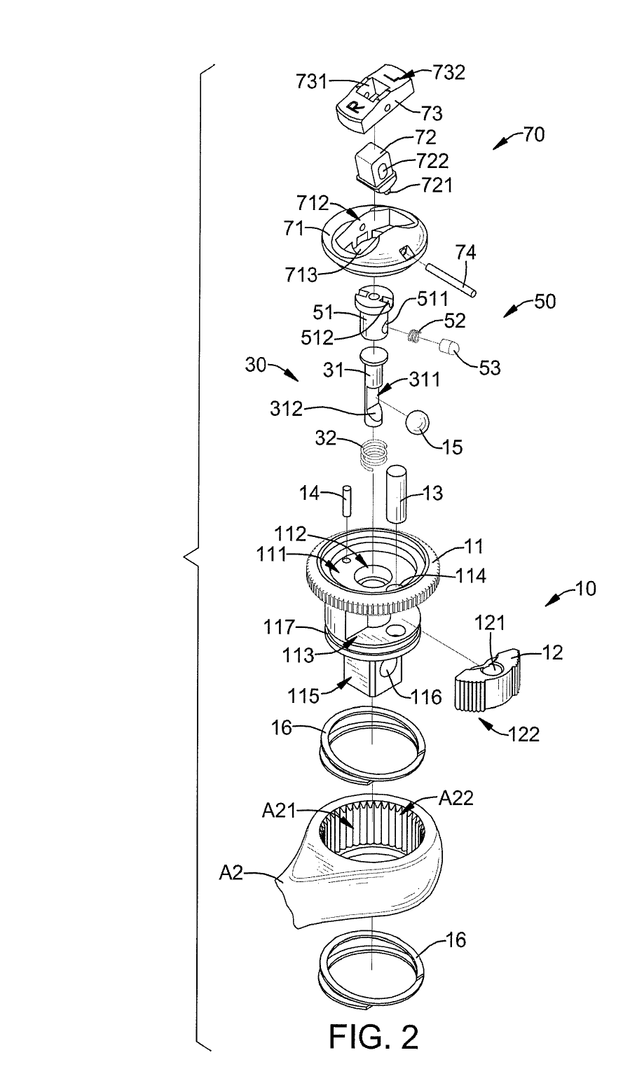

With reference to FIGS. 1 and 2, a ratchet device in accordance with the present invention comprises a ratchet head (10), a pressing device (30), a rotating device (50) and a switching device (70).

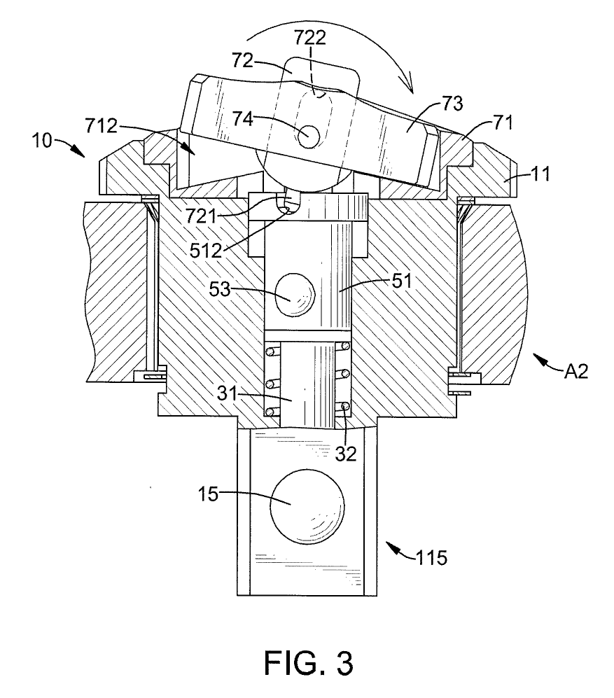

With further reference to FIG. 3, the ratchet head (10) has a ratchet body (11), a pawl (12), a pawl pin (13), a cover pin (14), a steel ball (15) and two rings (16).

The ratchet body (11) is substantially cylindrical and has a top, a bottom, an outer surface, a cover opening (111), a central hole (112), a pawl opening (113), a pin hole (114), an extending section (115), a ball hole (116) and a ring groove (117).

The cover opening (111) is round, is axially defined in the top of the ratchet body (11) and has a bottom. The central hole (112) is axially defined through the bottom of the cover opening (111). The pawl opening (113) is radially defined in the outer surface of the ratchet body (11), has a semi-round cross section and communicates with the central hole (112). The pin hole (114) is axially defined through the bottom of the cover opening (111) beside the central hole (112) and communicates with the pawl opening (113) and the cover opening (111). The extending section (115) protrudes from the bottom of the ratchet body (11). The ball hole (116) is radially defined in the extending section (115) and communicates with the central hole (112). The ring groove (117) is annular and is defined around the outer surface of the ratchet body (11) between the pawl opening (113) and the extending section (115) and is near the pawl opening (113).

The pawl (12) is pivotally mounted in the pawl opening (113) and has an inner surface, an aperture (121) and two pawl sides (122). The aperture (121) is defined through the pawl (12) and aligns with the pin hole (114). One of the pawl sides (122) selectively protrudes out from the pawl opening (113).

The pawl pin (13) is mounted in the pin hole (114) and the aperture (121).

The cover pin (14) is mounted on and protrudes from the bottom of the cover opening (111) beside the central hole (112) and the pin hole (114).

The steel ball (15) is retractably mounted in the ball hole (116) and protrudes out from the ball hole (116).

The rings (16) are mounted securely around the outer surface of the ratchet body (11). One of the rings (16) is above the pawl opening (113), and the other ring (16) is securely mounted in the ring groove (117). The rings (16) are used to position the ratchet head (10) that is mounted in a manual wrench (A). This can prevent the pawl (12) from moving up and down relative to the manual wrench (A).

The pressing device (30) is mounted in the central hole (112) and has a pressing rod (31) and a pressing spring (32). The pressing rod (31) is slidably mounted in the central hole (112) and has a top, an outer surface, a ball opening (311) and an inclined plane (312). The ball opening (311) is radially defined in the outer surface of the pressing rod (31), has a bottom and may enable the steel ball (15) to retract from the ball hole (116). The inclined plane (312) is formed on the bottom of the ball opening (311) and is above the steel ball (15). The inclined plane (312) provides a guiding effect to make the steel ball (15) move back into the ball hole (116). The pressing spring (32) is compressibly mounted around the outer surface of the pressing rod (31) beside the ball opening (311).

The rotating device (50) is rotatably mounted in the central hole (112) and has a rotating rod (51), a knob spring (52) and a knob (53).

The rotating rod (51) is rotatably and slidably mounted in the central hole (112) and has a top, a bottom, a knob hole (511) and two lump notches (512). The bottom of the rotating rod (51) abuts the top of the pressing rod (31). The knob hole (511) is radially defined in the rotating rod (51) and communicates with the pawl opening (113). The lump notches (512) are defined in the top of the rotating rod (51) and have a same diameter as the rotating rod (51).

The knob spring (52) is compressibly mounted in the knob hole (511). The knob (53) is mounted in the knob hole (511) between the pawl (12) and the knob spring (52) and presses the pawl (12) with a force provided by the knob spring (52).

The switching device (70) is mounted in the cover opening (111) and has a cover (71), a pivoting block (72), a switch (73) and a shaft (74).

The cover (71) is mounted securely in the cover opening (111) and has a top, a bottom, a protrusion hole, a switch opening (712) and a block hole (713).

The protrusion hole is defined in the bottom of the cover (71) and is inserted by the cover pin (14) to secure the cover (71) in the cover opening (111).

The switch opening (712) is rectangular, is defined in the top of the cover (71) and has a bottom. The block hole (713) is defined through the bottom of the switch opening (712) and aligns with the central hole (112). The pivoting block (72) is slidably mounted in the block hole (713), abuts the top of the rotating rod (51) and has a bottom, an outer surface, an eccentric lump (721) and an elongated hole (722). The eccentric lump (721) protrudes from the bottom of the pivoting block (72) and is inserted into one of the lump notches (512). The elongated hole (722) is radially defined through the outer surface of the pivoting block (72).

The switch (73) is pivotally mounted in the switching opening (712) and has a top surface, two ends, a through hole (731) and two signs (732). The through hole (731) is defined through the switch (73) and is mounted around the pivoting block (72). The signs (732) are mounted on the top surface respectively near the ends of the switch (73).

The shaft (74) is radially mounted in the cover (71) and through the elongated hole (722) and the switch (73) to pivotally mount the switch (73) on an axis of the shaft (74). Because the shaft (74) is mounted through the elongated hole (722), the pivoting block (72) can slide along the block hole (713) in a limited range.

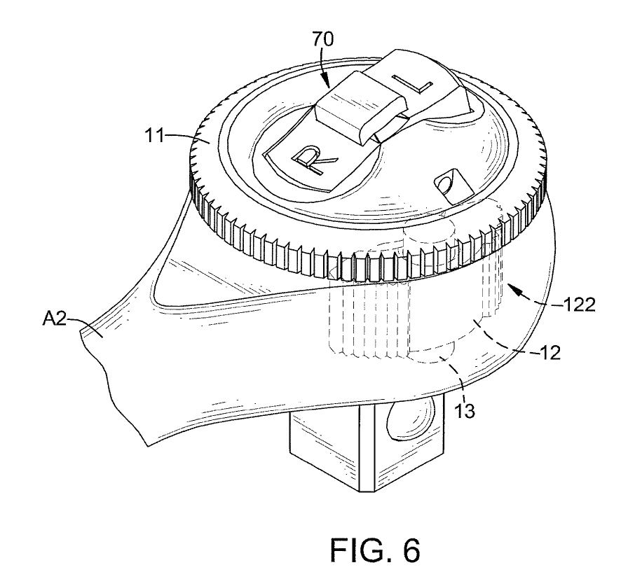

With reference to FIGS. 1, 2, and 6, the ratchet device in accordance with the present invention is assembled with a manual wrench (A). The manual wrench (A) has a handle (A1), a connecting section (A2), a section hole (A21) and a ratchet surface (A22). The structure of the manual wrench (A) may be conventional, so detailed description is omitted. The ratchet device is mounted in the section hole (A21) and one of the pawl sides (122) engages the ratchet surface (A22).

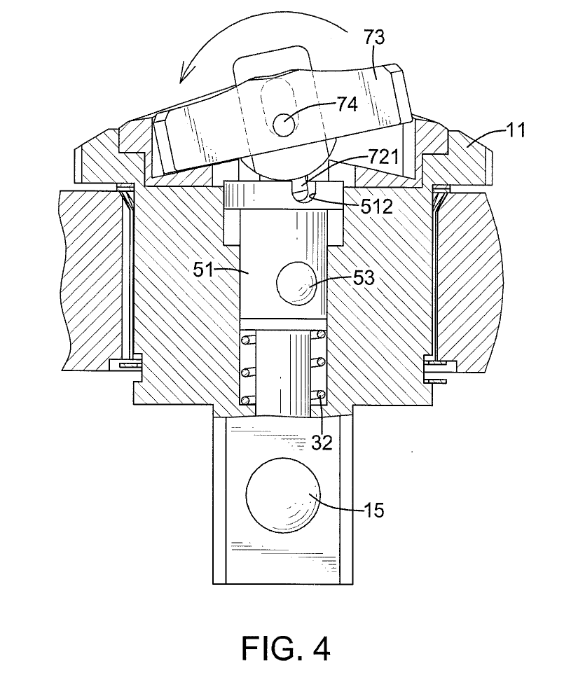

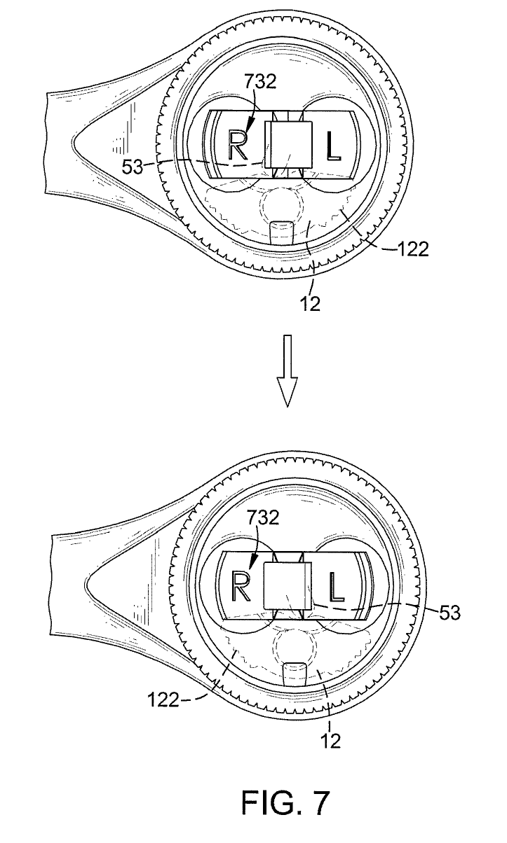

With reference to FIGS. 3, 4, and 7, in use, one sign (732) of the switch (73) is pressed and the switch (73) pivots on the axis of the shaft (74). Therefore, the pivoting block (72) is pivoted and the eccentric lump (721) is swung slightly. Because the eccentric lump (721) is inserted into the corresponding lump notch (512), the rotating rod (51) will be rotated slightly to make the knob (53) press another side of the inner surface of the pawl (12). Consequently, the pawl (12) will pivot and the other pawl side (122) will engage the ratchet surface (A22). With the switch (73) being pressed and pivoted, the pawl sides (122) can selectively engage the ratchet surface (A22) and an operational direction of the present invention can be assuredly changed.

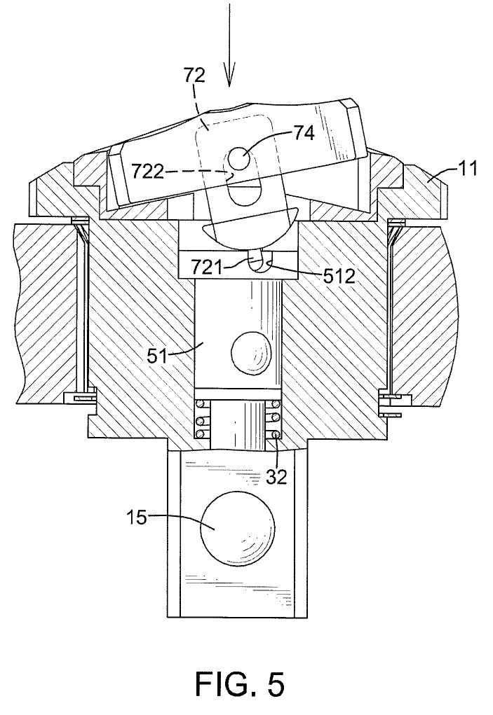

With reference to FIGS. 2, 4, and 5, a quick-releasing function of the present invention can be implemented and the ratchet body (11) can be pulled out easily from a sleeve. The sleeve is inserted by the extending section (115) and has a clamping groove into which the steel ball (15) protrudes to secure the ratchet body (11) in the sleeve. The structure of the sleeve may be conventional, so detailed description is omitted. When the pivoting block (72) is pressed down, the pivoting block (72) and the rotating rod (51) are both descended and the pressing spring (32) is compressed. Meanwhile, the steel ball (15) is retracted into the ball opening (311) and is held in the ball hole (116) completely. Accordingly, the ratchet body (11) can be removed from the sleeve.

From the above description, it is noted that the invention has the following advantages:

1. Handy Operation

An operational direction of the present invention can be changed by simply pressing the switch (73) to make the pawl sides (122) selectively engage the ratchet surface (A22). This is handy for operation even when a user's hands are greasy or slippery.

2. Positioning Design

Because of switching motion of the switch (73), the eccentric lump (721) can assuredly drive the rotating rod (51) to rotate in a fixed range. Consequently, the pawl (12) will pivot to an expected position. This can prevent the relative rotation between the pawl (12) and the ratchet surface (A22).

3. Convenient Use

Only one hand is needed to press the switch (73), so this is convenient in operation.

What is claimed is:

1. A ratchet device comprising:
a ratchet head having
a ratchet body having
a top;
an outer surface;
a central hole axially defined through the ratchet body;
a pawl opening radially defined in the outer surface of the ratchet body and communicating with the central hole; and
a pawl pivotally mounted in the pawl opening and having two pawl sides;
a rotating device rotatably mounted in the central hole and having
a rotating rod rotatably mounted in the central hole and having
a top;
a knob hole radially defined in the rotating rod and communicating with the pawl opening;
at least one lump notch defined on the top of the rotating rod;
a knob spring compressibly mounted in the knob hole; and
a knob mounted in the knob hole between the pawl and the knob spring and pressing the pawl with a force provided by the knob spring; and
a switching device mounted on the top of the ratchet body and having
a cover mounted securely on the top of the ratchet body and having
a top;
a switch opening defined in the top of the cover and having a bottom;
a block hole defined through the bottom of the switch opening and communicating with the central hole;
a pivoting block mounted in the block hole, abutting the top of the rotating rod and having
a bottom;
an eccentric lump protruding from the bottom of the pivoting block and inserted into one of the at least one lump notch; and
a switch pivotally mounted in the switching opening and having
a through hole defined through the switch and mounted around the pivoting block.

2. The ratchet device as claimed in claim 1, wherein
a pressing device is mounted in the central hole and has
a pressing rod slidably mounted in the central hole and having
a top;
an outer surface;
a ball opening radially defined in the outer surface of the pressing rod and having a bottom; and
an inclined plane formed on the bottom of the ball opening; and
a pressing spring compressibly mounted around the outer surface of the pressing rod beside the ball opening;
the rotating rod has a bottom that abuts the top of the pressing rod; and
the pivoting block is slidable along the block hole.

3. The ratchet device as claimed in claim 2, wherein
the pivoting block has an elongated hole that is radially defined through the pivoting block; and
the switching device has
a shaft radially mounted in the cover and through the elongated hole and the switch.

4. The ratchet device as claimed in claim 1, wherein
the ratchet body has a cover opening that is round, is axially defined in the top of the ratchet body and communicates with the central hole; and
the cover is mounted securely in the cover opening.

5. The ratchet device as claimed in claim 2, wherein
the ratchet body has a cover opening that is round, is axially defined in the top of the ratchet body and communicates with the central hole; and
the cover is mounted securely in the cover opening.

6. The ratchet device as claimed in claim 3, wherein
the ratchet body has a cover opening that is round, is axially defined in the top of the ratchet body and communicates with the central hole; and
the cover is mounted securely in the cover opening.

7. The ratchet device as claimed in claim 1, wherein
the switch has
a top surface;
two ends; and
two signs mounted on the top surface respectively near the ends of the switch.

8. The ratchet device as claimed in claim 2, wherein
the switch has
a top surface;
two ends; and
two signs mounted on the top surface respectively near the ends of the switch.

9. The ratchet device as claimed in claim 3, wherein
the switch has
a top surface;
two ends; and
two signs mounted on the top surface respectively near the ends of the switch.

10. The ratchet device as claimed in claim 4, wherein
the switch has
a top surface;
two ends; and
two signs mounted on the top surface respectively near the ends of the switch.

11. The ratchet device as claimed in claim 5, wherein
the switch has
a top surface;
two ends; and
two signs mounted on the top surface respectively near the ends of the switch.

12. The ratchet device as claimed in claim 6, wherein
the switch has
a top surface;
two ends; and
two signs mounted on the top surface respectively near the ends of the switch.
